(19) United States
(12) Patent Application Publication
(10) Pub. No.: US 2013/0087062 A1
(43) Pub. Date: Apr. 11, 2013

(54) Explosive nuclear fusion device

(71) Applicant: Archie Lou Tengzelius, New Port Richey, FL (US)

(72) Inventor: Archie Lou Tengzelius, New Port Richey, FL (US)

(21) Appl. No.: 13/317,052

(22) Filed: Oct. 11, 2011

(51) Int. Cl. F42D 1/00; B02C 23/00

(52) U.S. Cl. 102/332; 241/25

(57) ABSTRACT

This discovery describes a new process to produce large violent explosive quantities of thermal energy with a device through mass conversion under mild conditions by using hydride containing materials to be activated in the presence of group VIIIB and VIB elements causing nuclear fusion followed by sudden disassociation of the unstable result yielding stable products and large excess thermal energy.

### SUMMARY OF THE INVENTION

This invention relates to an explosive admixture within a sealed container detonated by heating to bring about a sudden release of large excess thermal energy as a result of nuclear fusion. Protons orbited by two electrons, also referred to as hydride ions provided by a finely divided metal hydride powder and mixed with a nickel or copper powder or derivatives thereof are caused to fuse by heating to a temperature exceeding 200 Celsius followed by disintegration of the resulting unstable nucleus yielding an explosive thermal energy release and products whose total mass is predicted to be diminished by current theories of Physics.

### DESCRIPTION OF THE INVENTION

This invention relates to the discovery that hydride ions contained in finely divided metal hydride prepared under dry inert conditions are activated by heating in the presence of finely divided nucleus within nickel or copper or chemical compounds thereof. Fusion with said nuclei results in unstable products. Said products subsequently explosively disintegrate into stable species accompanied by extensive liberation of heat energy.

1. A method for creating an explosive by mixing a finely divided metal hydride powder prepared and handled under inert atmosphere conditions and Group VIIIB or Group VIB metals or compounds thereof also as a finely divided powder prepared and handled within an inert atmosphere and placing said mixture in a steel cavity capable of being tightly sealed. A self sustained violent exothermic explosive reaction is initiated by heating the capsule to a temperature above 200 Celsius.

2. A method of initiating the explosion as described in claim 1, by igniting a thermite coating formed around the steel capsule containing the powder admixture.

3. A method for catalyzing the explosive as described in previous claims by admixing up to 10 percent by weight of lithium borohydride in a finely divided state prepared and handled under a dry inert atmosphere.

4. A method for carrying out an isothermal reaction as described in previous claims whereby finely divided boron, boron nitride or boron carbide is substituted for lithium borohydride.

5. A method for preparing the explosive device as described in previous claims whereby finely divided nickel, raney nickel or nickel hydride prepared under dry inert atmosphere is admixed with magnesium hydride prepared by repeated cycles of heating magnesium turnings under a hydrogen atmosphere followed by ball milling using charcoal in small mounts to facilitate embrittlement. Repeating this process many times results in a very reactive magnesium hydride of high purity which was carefully handled in a dry box under hydrogen atmosphere for explosive preparation.

6. A method for preparing the explosive device as described in previous claims whereby solid constituents are suspended in inert to the substances contained therein.

7. A method for preparing the explosive device as described in previous claims whereby solid powdered constituents are mechanically compressed prior to encapsulating within a steel chamber.
